(19) United States
(12) Patent Application Publication
(10) Pub. No.: US 2025/0169473 A1
(43) Pub. Date: May 29, 2025

(54) REVERSIBLE PET HARNESS

(71) Applicant: SASSY WOOF LLC, Sterling, VA (US)

(72) Inventors: Christine N. CHANG, Sterling, VA (US); Arturo CHANG, Sterling, VA (US)

(21) Appl. No.: 18/843,467

(22) PCT Filed: Mar. 3, 2023
(86) PCT No.: PCT/US2023/063651

§ 371 Date: Sep. 3, 2024

Related U.S. Application Data
(60) Provisional application No. 63/316,170, filed on Mar. 3, 2022.

(51) Int. Cl. A01K 27/00

(52) U.S. Cl. CPC A01K 27/002; A01K 27/008

(57) ABSTRACT

A reversible harness for a pet includes a chest panel having a first side and a second side. There are straps coupled to the chest panel and configured to secure the chest panel to a chest of the pet, the straps include at least one fastening member. There is a back panel having a first side and a second side, and straps having a fastening member and coupled to the back panel and configured to secure the back panel to a back of the pet. The reversible harness is adjustable between a first configuration in which the second side of the chest panel faces the first side of the back panel and a second configuration in which the first side of the chest panel faces the second side of the back panel.

### CROSS-REFERENCE TO RELATED APPLICATIONS

This application claims the benefit of U.S. Provisional Patent Application No. 63/316,170 filed Mar. 3, 2022 entitled “Reversible Pet Harness”, which is incorporated by reference herein in its entirety.

### TECHNICAL FIELD

The present disclosure generally relates to a reversible pet harness and, more particularly, to a pet harness having a reversible chest panel and a reversible back panel.

### SUMMARY

In one embodiment there is a reversible harness for a pet including a chest panel having a first side and a second side opposite the first side, a first plurality of straps coupled to the chest panel and configured to secure the chest panel to a chest of the pet, the first plurality of straps including at least one first fastening member coupled to at least one strap of the first plurality of straps, a back panel having a first side and a second side opposite the first side, and a second plurality of straps coupled to the back panel and configured to secure the back panel to a back of the pet, the second plurality of straps including at least one second fastening member coupled to at least one strap of the second plurality of straps and configured to detachably couple to the at least one first fastening member. The reversible harness is adjustable between a first configuration in which the second side of the chest panel faces the first side of the back panel and a second configuration in which the first side of the chest panel faces the second side of the back panel.

In some embodiments, the reversible harness further includes a first aperture defining an opening extending through the chest panel from the first side to the second side of the chest panel, a first ring positioned in the opening and defining a first ring opening, and a first central strap extending across the opening of the first aperture and through the first ring opening of the first ring to moveably couple the first ring relative to the chest panel, the opening of the first aperture and first central strap configured to allow the first ring to extend outwardly at least primarily from the first side of the chest panel in a first position and outwardly at least primarily from the second side of the chest panel in a second position. In some embodiments, the first central strap is sandwiched between the first side and the second side of the chest panel and extends above and below the first aperture. In some embodiments, the first central strap is fixedly coupled to the chest panel.

In some embodiments, the reversible harness further includes a second aperture defining an opening extending through the back panel from the first side to the second side of the back panel, a second ring positioned in the opening of the second aperture and defining a second ring opening, and a second central strap extending across the opening of the second aperture and through the second ring opening of the second ring to moveably couple the second ring relative to the back panel, the opening of the second aperture and second central strap configured to allow the second ring to extend outwardly at least primarily from the first side of the back panel in a first position and outwardly at least primarily from the second side of the back panel in a second position. In some embodiments, the second central strap is sandwiched between the first side and the second side of the back panel and extends above and below the second aperture. In some embodiments, the second central strap is fixedly coupled to the back panel.

In some embodiments, the first ring and second ring are each D-shaped ring. In some embodiments, the reversible harness is adjustable between the first configuration, the second configuration, a third configuration in which the second side of the chest panel faces the second side of the back panel, and a fourth configuration in which the first side of the chest panel faces the first side of the back panel. In some embodiments, the at least one second fastening member engages the at least one first fastening member when the reversible harness is in the third configuration and the fourth configuration. In some embodiments, the first plurality of straps includes four first fastening members and the second plurality of straps includes four second fastening members, each of the four first fastening members configured to detachably couple to any one of the four second fastening members. In some embodiments, the back panel is detachable from the chest panel.

In some embodiments, the chest panel defines one or more channels extending at least partially between the first side and second side of the chest panel and configured to adjustably couple the first plurality of straps to the chest panel. In some embodiments, the back panel defines one or more channels extending at least partially between the first side and second side of the back panel and configured to adjustably couple the second plurality of straps to the back panel. In some embodiments, the first side of the chest panel includes a first pocket fixedly coupled to the first side of the chest panel, and the second side of the chest panel includes a second pocket fixedly coupled to the second side of the chest panel. In some embodiments, the back panel includes a ring coupled to and extending outwardly from a periphery of the back panel. In some embodiments, the chest panel and back panel are each comprised of a fabric material. In some embodiments, the first side and second side of each of the chest panel and back panel include a color or pattern than that is different than each other first side and second side of each of the chest panel and back panel.

In another embodiment there is a reversible pet harness including a chest panel including a first side and a second side, a back panel including a first side and a second side, the back panel and chest panel oriented relative to one another such that the first side of the back panel faces the second side of the chest panel, and a plurality of straps detachably coupling the chest panel to the back panel. The orientation of each of the chest panel and back panel are reversible relative to and independent of the other.

In another embodiment there is a reversible pet harness including a chest panel having a first side and a second side opposite the first side, a first plurality of straps coupled to the chest panel and configured to secure the chest panel to a chest of a pet, the first plurality of straps including at least one first fastening member coupled to at least one strap of the first plurality of straps, a first aperture defining an opening extending through the chest panel from the first side to the second side of the chest panel, a first ring positioned in the opening and defining a first ring opening, a first central strap extending across the opening of the first aperture and through the first ring opening of the first ring to moveably couple the first ring relative to the chest panel, the opening of the first aperture and first central strap configured to allow the first ring to extend outwardly at least primarily from the first side of the chest panel in a first position and outwardly at least primarily from the second side of the chest panel in a second position, a back panel having a first side and a second side opposite the first side, a second plurality of straps coupled to the back panel and configured to secure the back panel to a back of the pet, the second plurality of straps including at least one second fastening member coupled to at least one strap of the second plurality of straps, a second aperture defining an opening extending through the back panel from the first side to the second side of the back panel, a second ring positioned in the opening of the second aperture and defining a second ring opening, and a second central strap extending across the opening of the second aperture and through the second ring opening of the second ring to moveably couple the second ring relative to the back panel, the opening of the second aperture and second central strap configured to allow the second ring to extend outwardly at least primarily from the first side of the back panel in a first position and outwardly at least primarily from the second side of the back panel in a second position. The reversible harness is adjustable between a first configuration in which the second side of the chest panel faces the first side of the back panel and a second configuration in which the first side of the chest panel faces the second side of the back panel, and the at least one second fastening member engages the at least one first fastening member when the reversible harness is in the first configuration and the second configuration.

### BRIEF DESCRIPTION OF THE DRAWINGS

The following detailed description of embodiments of the reversible pet harness, will be better understood when read in conjunction with the appended drawings of an exemplary embodiment. It should be understood, however, that the invention is not limited to the precise arrangements and instrumentalities shown.

In the drawings:

FIG. 1 is a front perspective view of a reversible pet harness in accordance with an exemplary embodiment of the present invention; and

FIG. 2 is a front perspective view of the plurality of straps coupled to the reversible pet harness of FIG. 1;

FIG. 3 is an exploded view of the chest panel of the reversible pet harness of FIG. 1;

FIG. 4 is a magnified side cross-sectional view of the chest panel of FIG. 1;

FIG. 5A is a front elevational view of the chest panel of FIG. 1;

FIG. 5B is a rear elevational view of the chest panel of FIG. 1;

FIG. 6A is a front elevational view of the back panel of FIG. 1;

FIG. 6B is a rear elevational view of the back panel of FIG. 1;

FIG. 7A is front perspective view of the reversible pet harness of FIG. 1 in a first configuration;

FIG. 7B is a front perspective view of the reversible pet harness of FIG. 1 in a second configuration;

FIG. 7C is a front perspective view of the reversible pet harness of FIG. 1 in a third configuration;

FIG. 7D is a front perspective view of the reversible pet harness of FIG. 1 in a fourth configuration;

FIG. 8A-8E are side cross-sectional side views of the reversible pet harness of FIG. 1 illustrating a repositionable chest ring transitioning from a first position to a second position;

FIG. 8F is a front perspective cross-sectional view of the chest panel of the reversible pet harness of FIG. 1 with the repositionable chest ring in the transitional position shown in FIG. 8B.

FIG. 9A is a front elevational view of the chest panel of FIG. 1;

FIG. 9B is a rear elevational view of the chest panel of FIG. 1;

FIG. 10A is a front elevational view of the back panel of FIG. 1;

FIG. 10B is a rear elevational view of the back panel of FIG. 1;

FIG. 11A is a front perspective view of the reversible pet harness of FIG. 1;

FIG. 11B is a rear perspective view of the reversible pet harness of FIG. 1; and

FIG. 12 is a front perspective view of the reversible pet harness of FIG. 1 shown on a dog.

### DETAILED DESCRIPTION

There is disclosed herein, embodiments of a reversible pet harnesses having a chest panel and back panel and configured to be worn by a pet in two or more configurations. The pet harness may be reversible to provide multiple distinct appearances (e.g., different patterns, colors), and/or different materials (e.g., mesh, netting, fabric) disposed on opposing sides of each of the chest panel and back panel. In some embodiments, the pet harness is reversible such that either a first side or a second side of the chest panel and back panel is in direct contact with a pet wearing the harness. In some embodiments, the pet harness is reversible to provide hygiene benefits (e.g., a side which has built up dirt or debris may be reversed such that it faces toward the pet/animal wearing the pet harness).

In some embodiments, the reversible pet harness includes a repositionable ring disposed on the chest panel and back panel, each repositionable ring may receive a leash, lead, and/or identification tags. In some embodiments, the repositionable rings may receive a leash and one or more identification tags simultaneously. In some embodiments, the reversible pet harness may be a no-pull type pet harness configured to reduce a pet and/or animal's ability to pull against a leash and/or lead connected to the pet harness. In some embodiments, the repositionable rings are configured to be repositioned from one side to another of the respective chest and back panel such that ring may receive a leash and/or lead when the pet harness is in any of a first, second, third, or fourth configurations. In some embodiments, the ring being repositionable may allow for the pet harness to be reversible without the need to provide additional rings disposed on the chest panel or back panel of the pet harness.

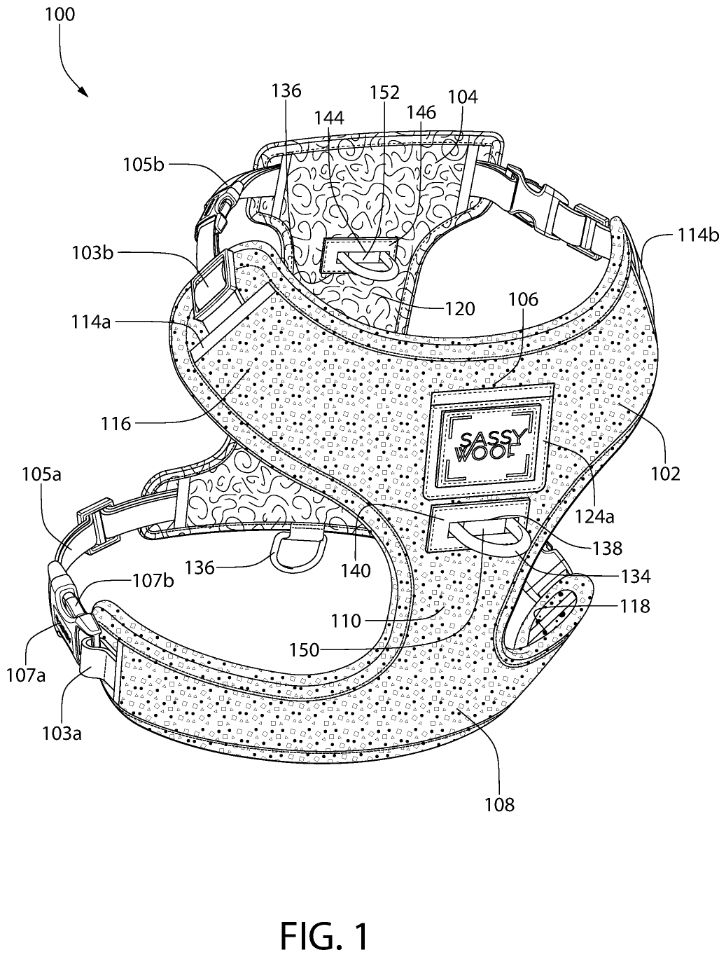

Referring to the drawings in detail, wherein like reference numerals indicate like elements throughout, there is shown in FIGS. 1-12 a reversible pet harness, generally designated 100, in accordance with an exemplary embodiment of the present invention. In FIGS. 1, 3, 5A-7D, and 8F-12, various surfaces of the reversible pet harness 100 are depicted as including different visual patterns for the purpose of illustrating aspects of the present disclosure. For example, the patterns illustrated herein may represent a contrast in appearance between different surfaces of the reversible pet harness 100. The exact patterns illustrated on surfaces of the reversible pet harness 100 are intended to be non-limiting and in some embodiments the patterns illustrated herein may be replaced with one or more other patterns, colors, textures and/or materials.

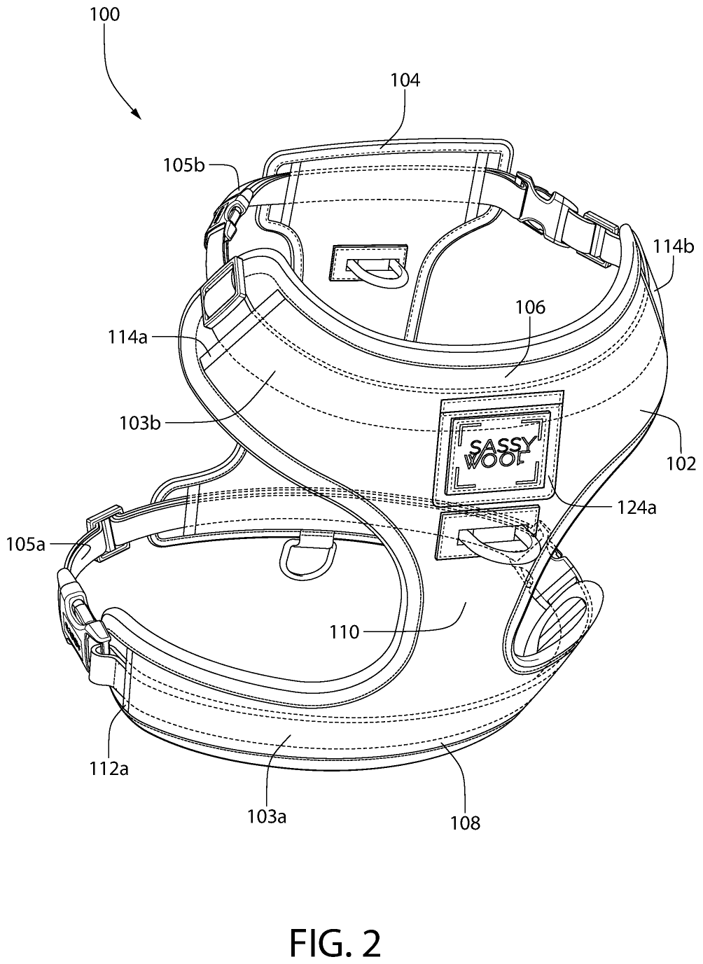

Referring to FIGS. 1-2, there is shown a reversible pet harness 100 configured to be worn by a pet or animal (e.g., cat, dog), also referred to as harness 100. The harness 100 may include a chest panel 102 and a back panel 104 coupled to one another. The chest panel 102 may include a first side 116 and a second side 118 opposite the first side 116. The first side 116 and second side 118 may each define a separate and distinct layer of the chest panel 102. For example, the first side 116 may define a first layer and the second side 118 may define a second layer. In some embodiments, the first side 116 and second side 118 are fixedly coupled to one another by, for example, but not limited to, stitching and/or adhesives. In some embodiments, the first side 116 may be visually and/or texturally different from the second side 118. In other embodiments, the first side 116 may be visually and/or texturally the same as the second side 118. In some embodiments, the first side 116 and/or second side 118 include a fabric. In some embodiments, the fabric may include designs which are printed, adhered to, and/or stitched onto the fabric. In some embodiments, the first side 116 and/or second side 118 may include a mesh material that is coupled onto the respective first side 116 and/or second side 118.

In some embodiments, the back panel 104 includes a first side 120 and a second side 122 (shown in FIG. 6B) that is opposite the first side 120. Similar to the chest panel 102, the first side 120 and second side 122 may each define a separate and distinct layer of the back panel 104. For example, the first side 120 may define a first layer and the second side 122 may define a second layer. The first side 120 and second side 118, of the back panel 104, may be fixedly coupled to one another by, for example, but not limited to, stitching and/or adhesives. In some embodiments, the first side 120 may be visually and/or texturally different from the second side 122. In other embodiments, the first side 120 may be visually and/or texturally the same as the second side 122. In some embodiments, the first side 120 and/or second side 122 include a fabric. In some embodiments, the fabric may include designs which are printed, adhered to, and/or stitched onto the fabric. In some embodiments, the first side 120 and/or second side 122 may include a mesh material that is coupled onto the respective first side 120 and/or second side 122.

In some embodiments, one or more of the sides of the chest panel 102 and back panel 104 is visually and/or texturally different from one or more other sides of the chest panel 102 and back panel 104. For example, the first side 120 of the back panel 104 may include a design, color, pattern, and/or texture that is different from the front side 116 of the chest panel 102. In some embodiments, each of the sides of the chest panel 102 and back panel 104 is visually and/or texturally different from each of side of the chest panel 102 and back panel 104. For example, the first sides 116, 120 and second sides 118, 122 of each of the respective chest panel 102 and back panel 104 may each be visually and/or texturally different. In some embodiments, one or more sides of the chest panel 102 and back panel 104 may be visually and/or texturally the same as one or more other sides of the chest panel 102 and back panel 104. For example, and without limiting the generality of the foregoing sentence, the first side 116 of the chest panel 102 and first side 120 of back panel 102 may be visually and/or texturally the same (e.g., may include the same pattern or design).

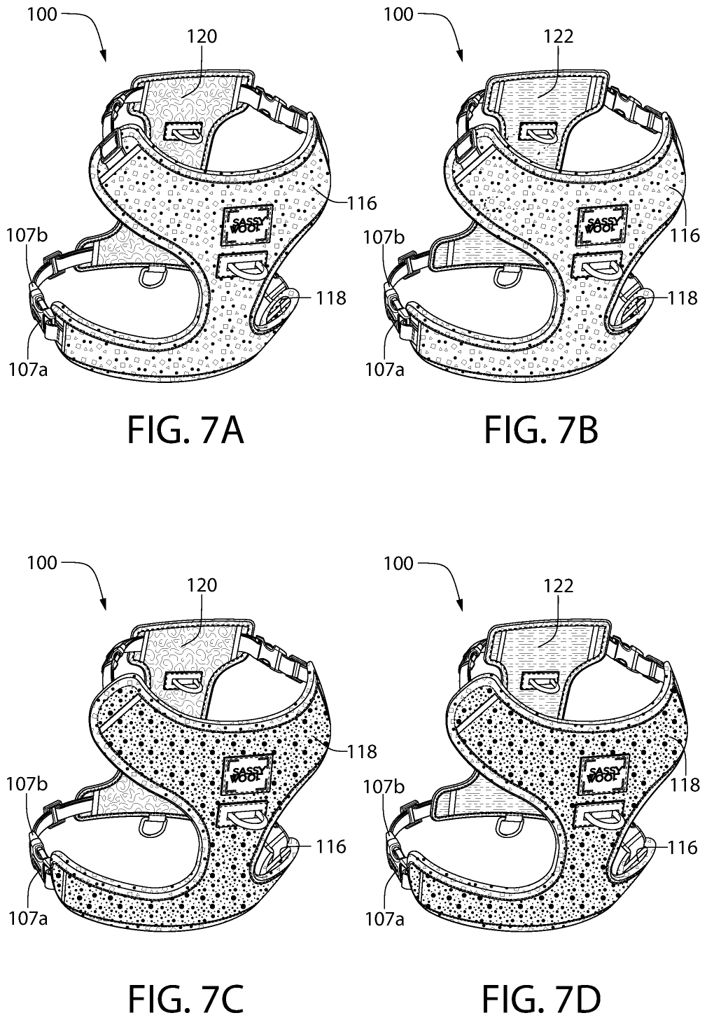

In some embodiments, by providing one or more sides of the chest panel 102 and back panel 104 having a different appearance than one or more other sides of the chest panel 102 and back panel 104, the reversible harness 100 may be worn by a pet in one or more visually distinct configurations. For example, in the configuration shown in FIG. 1, the first side 116 of the chest panel 102 and the second side 122 (shown in FIG. 6B) of the back panel 104 face away from one another and from a pet wearing the harness 100. As such, the second side 118 of the chest panel 102 and first side 120 of the back panel 104 are facing one another and toward a pet wearing the harness 100. In this manner, the body of the pet may substantially obscure the second side 118 of the chest panel 102 and the first side 120 of the back panel 104, while not obscuring the first side 116 and second side 122 of the respective chest and back panel 102, 104. In some embodiments, the harness 100 includes one or more straps, coupling the chest panel 102 to the back panel 104 such that the harness is capable of being repositioned between two or more configurations discussed in greater detail with reference to FIGS. 7A-7D.

In some embodiments, there is a first plurality of straps, generally designated 103, coupled to the chest panel 102 and a second plurality of straps, generally designated 105, coupled to the back panel 104. The first plurality of straps 103 may be configured to couple the chest panel 102 to the chest of a pet. In some embodiments, the first plurality of straps 103 includes a first strap 103a and a second strap 103b each coupled to the chest panel 102. The first strap 103a and/or second strap 103b may be adjustable relative to the chest panel 102. For example, the first strap 103a and second strap 103b may be moved or rotated independent of one another and relative to the chest panel 102. The second plurality of straps 105 may be configured to couple the back panel 104 to the back of the pet. In some embodiments, the second plurality of straps 105 includes a first strap 105a and a second strap 105b each coupled to the back panel 104. In some embodiments, the first strap 105a and/or second strap 105b may be adjustable relative to the back panel 104.

In some embodiments, the second plurality of straps 105 is configured to couple the back panel 104 to the chest panel 102. For example, the second plurality of straps 105 may be coupled to the first plurality of straps 103 such that the back panel 104 is coupled to the chest panel 102. In some embodiments, the first plurality of straps 103 may include one or more respective fastening members configured to engage with a corresponding fastening member of the second plurality of straps 105 such that the first and second plurality of straps 103, 105 may be coupled to one another. There may be at least one first fastening member 107a coupled to the first plurality of straps 103 and at least one second fastening member 107b coupled to the second plurality of straps 105. In some embodiments, the at least one first fastening member 107a is coupled to a terminal end of a strap of the first plurality of straps 103. For example, the first fastening member 107a may be coupled to a terminal end of the first strap 103a and/or second strap 103b. In some embodiments, the at least one second fastening member 107b is coupled to a terminal end of a strap of the second plurality of straps 105. For example, the second fastening member 107b may be coupled to a terminal end of the first strap 105a and/or second strap 105b.

In some embodiments, there is a fastening member coupled to each terminal end of each strap included in the first plurality of straps 103 and second plurality of straps 105. For example, there may be a first fastening member 107a coupled to the terminal ends of the first strap 103a and second strap 103b of the first plurality of straps 103. Similarly, there may be a second fastening member 107b coupled to the terminal ends of the first strap 105a and second strap 105b of the second plurality of straps 105. In other embodiments, there is a single fastening member coupled to one terminal end of each strap included in the first plurality of straps 103 and second plurality of straps 105. For example, there may be a first fastening member 107a coupled to a terminal end of the first strap 103a and second strap 103b of the first plurality of straps 103. The first fastening members 107a may be coupled to the corresponding first strap 103a and second strap 103b at similar terminal ends. For example, the first fastening members 107a may be coupled to the left-most terminal end or right-most terminal end of each of the first strap 103a and second strap 103b. Similarly, the first strap 105a and second strap 105b may each include a second fastening member 107b coupled to a single terminal end of the straps 105a, 105b. The second fastening members 107b may be coupled to the corresponding straps 105a, 105b at similar terminal ends (e.g., both fastening members 107b coupled to either the right-most or left-most terminal ends). In some embodiments, the back panel 104 is detachable from the chest panel 102. For example, by providing fastening members 107a, 107b coupled to each terminal end of straps 103a, 103b, 105a, 105b, the chest panel 102 may be detachably coupled to the back panel 104.

In some embodiments, the first fastening members 107a and second fastening members 107b may each be a respective half of any conventional fastener known to those skilled in the art. In some embodiments, the first and second fastening members 107a, 107b may be respective halves of a clasp or side release buckle. For example, one or more of the first fastening members 107a may be the female member of a side release buckle and one or more of the second fastening members 107b may be the male member of a side release buckle. In some embodiments, the fastening members coupled to the terminal ends of any one strap (e.g., strap 103a, 103b, 105a, 105b) are the same as each other. For example, the first fastening members 107a coupled to the terminal ends of the first strap 103a may each be the female member of a side release buckle. The corresponding fastening members, such as the second fastening members 107b coupled to the first strap 105b of the second plurality of straps 105, may each be the male member of a side release buckle.

By providing first fastening members 107a that are the same half (e.g., male member, female member) of the type of fastening member used and providing second fastening members 107b that are the remaining half (e.g., male member, female member) on corresponding straps (e.g., the first straps 103a and 105a, the second straps 103b and 105b) of the chest panel 102 and back panel 104, each of the chest panel 102 and back panel 104 may be rotated relative to and independent of one another such that any combination of sides (e.g., first sides 116 and 120, and second sides 118 and 122) of the chest panel 102 and back panel 104 may face one another. In some embodiments, each of the first fastening members 107a coupled to the first plurality of straps 103 are the same half of the desired type of fastening member. For example, each of the first fastening members 107a may be either the male member or female member of a side release buckle type fastening member. Similarly, each of the second fastening members 107b coupled to the second plurality of straps 105 may be the remaining half of the desired type of fastening member. For example, each of the second fastening members 107b may be the female member of a side release buckle type fastening member when the first fastening members 107a are the male member, and vice versa.

In some embodiments, when each of straps 103a, 103b, 105a, 105b include a single fastening member 107a, 107b, the remaining terminal ends may be fixedly coupled to one another. For example, when each of the straps 103a, 103b, 105a, 105b include a corresponding fastening member 107a, 107b coupled to a left-most terminal end of said straps, the right-most terminal ends of the first straps 103a, 105a may be fixedly coupled to one another and the right-most terminal ends of the second straps 103b, 105b may be fixedly coupled to one another.

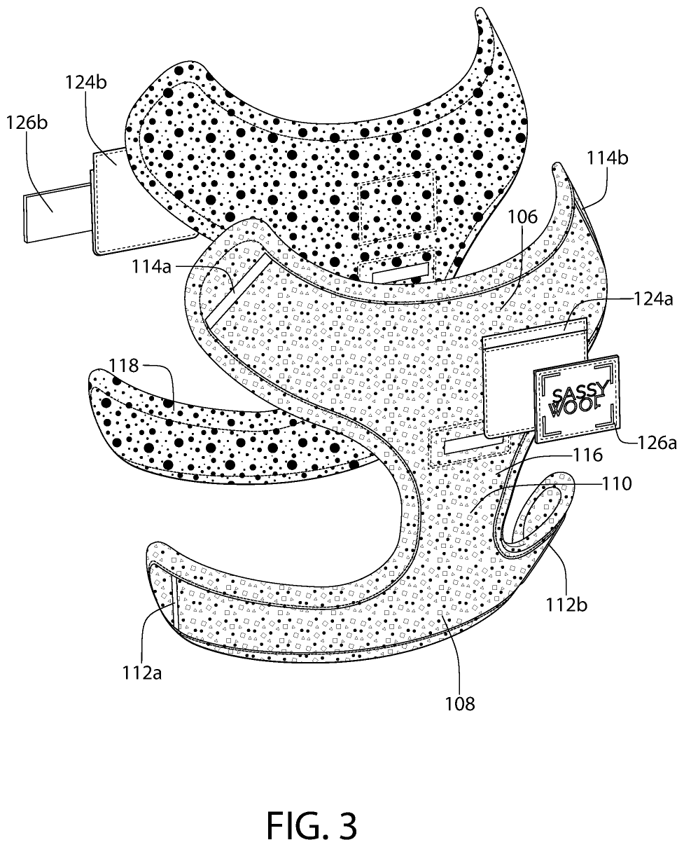

Referring to FIGS. 2-3, in some embodiments, the first strap 103a and second strap 103b of the first plurality of straps are coupled to the chest panel 102 opposite one another. For example, the chest panel 102 may include a top section 106, a bottom section 108, and a central section 110 extending between the top section 106 and bottom section 108. The first strap 103a may be coupled to the bottom section 108 and the second strap 103b may be coupled to the top section 106. In some embodiments, the chest panel 102 includes one or more channels configured to couple the first plurality of straps 103 to the chest panel 102. For example, the chest panel 102 may include a first bottom section opening 112a and a second bottom section opening 112b.

There may be a channel extending between the first bottom section opening 112a and the second bottom section opening 112b that the first strap 103a may pass through. Similarly, the chest panel 102 may include a first top section opening 114a and a second top section opening 114b. There may be a channel extending between the first top section opening 114a and second top section opening 114b that the second strap 103b may pass through. In some embodiments, the channel extending between the bottom section openings 112a and 112b and/or the channel extending between the top section openings 114a and 114b may be sandwiched between the first side 116 and second side 118 of the chest panel 102. In this manner, the portions of the first strap 103a and second strap 103b that is positioned within the respective channels is not exposed at an exterior surface of the chest panel 102. In some embodiments, one or more of the first strap 103a and second strap 103b may be rotated and/or moved within the corresponding channels. In some embodiments, one or more of the first strap 103a and second strap 103b may be decoupled from the corresponding channel. For example, the straps 103a and 103b may be slid into and out of the corresponding channels. In other embodiments, the straps 103a and 103b are fixedly coupled to the chest panel 102.

In some embodiments, the harness 100 may include one or more pockets configured to provide an amount of storage on the harness 100. There may be one or more pockets 124a, 124b coupled to the first side 116 and/or second side 118 of the chest panel. In some embodiments, the first pocket 124a is coupled to the first side 116 and the second pocket 124b is coupled to the second side 118. The first pocket 124a may extend outwardly from the first side 116 and the second pocket 124b may extend outwardly from the second side 118 of the chest panel 102. In some embodiments, the first pocket 124a is fixedly coupled to the first side 116 (e.g., stitching, adhesives) and the second pocket 124b is fixedly coupled to the second side 118 (e.g., stitching, adhesives). The pockets 124a, 124b may be positioned on the top section 106 opposite one another (e.g., on the first side 116 and second side 118). The pockets 124a, 124b may include an opening such that a user may store and retrieve items within the respective pocket 124a, 124b. For example, a user may store an item such as, but not limited to, animal waste bags, identification tags, pet food, within the first pocket 124a and/or second pocket 124b such that said items may be easily stored and retrieved as desired. In some embodiments, there may be a label 126a, 126b coupled to the outer surface of the first and second pockets 124a, 124b. The labels 126a, 126b may include any text, patterns, designs, and/or any other visual appearance and texture.

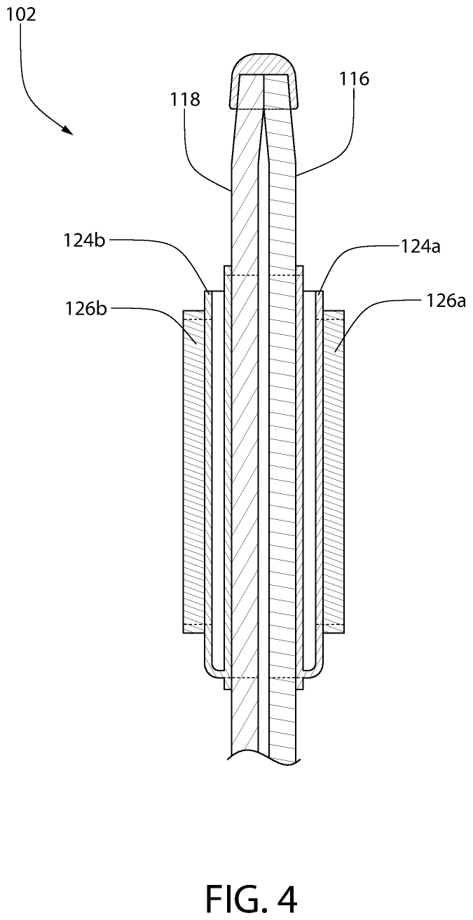

Referring to FIG. 4, a magnified cross-sectional view of the chest panel 102 is shown. In some embodiments, the first side 116 and second side 118 are fixedly coupled to one another proximate a periphery of each of the first side 116 and second side 118. For example, the periphery of both the first side 116 and second side 118 may be stitched and/or adhered to one another. In this manner, the first side 116 and second side 118 may be fixedly coupled to one another while also providing a space between the first side 116 and second side 118 to allow one or more straps or other components of the harness 100 to be at least partially disposed within. For example, as shown in FIG. 4, the first side 116 and second side 118 are coupled to one another along a periphery of each and spaced from one another interior to the periphery. In this manner, the first side 116 and second side 118 may be capable of being moved closer to and away from one another in the space interior to the periphery where the sides 116, 118 are coupled to one another.

In some embodiments, the first pocket 124a is fixedly coupled to the first side 116 via stitching and/or adhesive such that the stitching and/or adhesive does not extend from the first pocket 124a, through the first side 116 and through the second side 118. In this manner, the first pocket 124a may be coupled to the first side 116 while allowing the first side 116 to be spaced from the second side 118, proximate the first pocket 124a. The second pocket 124b may be coupled to the second side 118 in generally the same manner.

Although not shown in FIG. 4, the first side 120 and second side 122 of the back panel 104 may be coupled to one another in generally the same manner as the chest panel 102. For example, the first side 120 and second side 122 may be coupled to one another along a periphery of each side 120 and 122. The first side 120 and second side 122 may be coupled to one another via stitching and/or adhesives. In this manner, there may be a space between the first side 120 and second side 122 of the back panel within which one or more straps and/or other components of the harness 100 may be at least partially positioned. In some embodiments, and although not shown, the back panel 104 may include one or more pockets coupled to the back panel 104 in generally the same manner as pockets 124a, 124b.

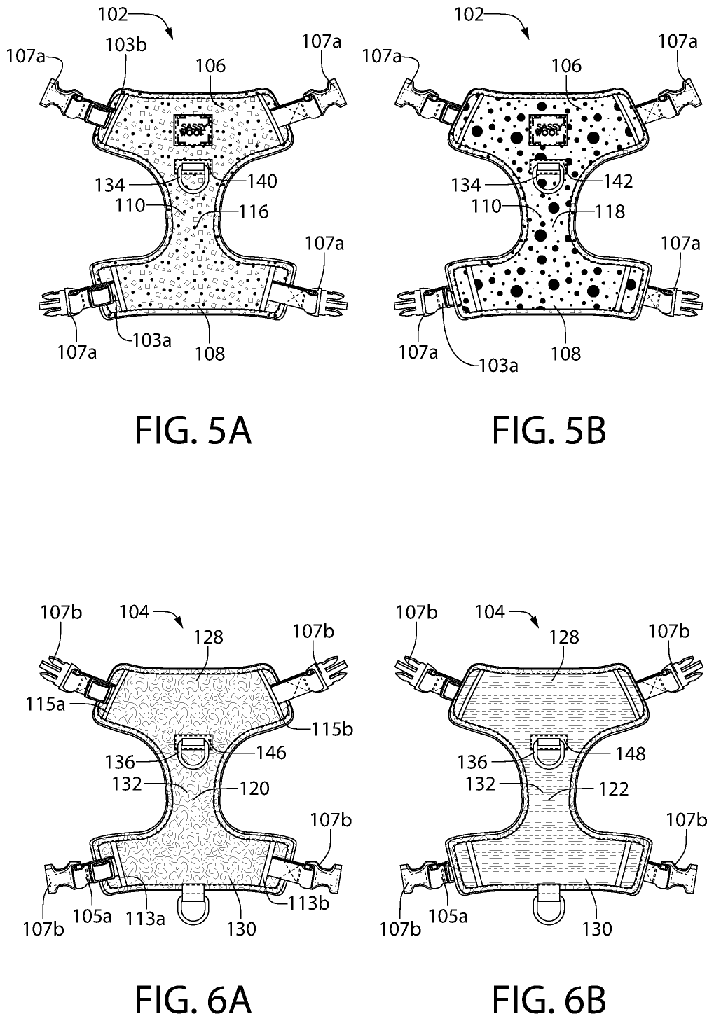

Referring to FIGS. 5A-5B, front and rear elevational views of the chest panel 102 are shown. The chest panel 102 may have a generally I-shape, a frusto-conical top portion and a generally T-shaped bottom portion. The chest panel 102, when worn by a pet and/or animal, may be configured to wrap at least partially around the neck and/or chest of the pet above the pet's front legs (e.g., top section 106), extend along a portion of the pet's chest to below the pet's front legs (e.g., central section 110), and extend at least partially around the ribs of the pet above the belly and below the front legs of the pet (e.g., bottom section 108). The central section 110 may extend along a length of the harness 100. The top section 106 may be disposed above the central section 110 and extend along a width of the harness 100. The bottom section 108 may be disposed opposite the top section 106 (e.g., below the central section 110) and extend along a width of the harness 100. In some embodiments, the central section 110, top section 106, and bottom section 108 are a uniform construct. In FIGS. 5A-5B, the first fasteners 107a coupled to the first strap 103a are the male members of a side release buckle and the first fasteners 107a coupled to the second strap 103b are female members of a side release buckle. However, it will be understood that each of the first fasteners 107a coupled to the first strap 103a and second strap 103b may be the male or female members of a type of fastener. In some embodiments, the first side 116 includes a first visual appearance (e.g., pattern, design, color) and the second side 118 includes a second visual appearance that is different than the first visual appearance.

Referring to FIGS. 6A-6B, there is shown front and rear elevational views of the back panel 104. The back panel 104 may include a top section 128, a bottom section 130 opposite the top section 128, and a central section 132 extending between the top section 128 and bottom section 130. The back panel 104 may have a generally I-shape, a frusto-conical top portion and a generally T-shaped bottom portion. The back panel 104, when worn by a pet and/or animal, may be configured to wrap at least partially around the nape and/or back of the pet above the pet's front legs (e.g., top section 128), extend along a portion of the pet's back to below the pet's front legs (e.g., central section 132), and extend towards and/or at least partially around the ribs of the pet below the front legs of the pet (e.g., bottom section 130). The central section 132 may extend along a length of the harness 100. The top section 128 may be disposed above the central section 132 and extend along a width of the harness 100. The bottom section 130 may be disposed opposite the top section 128 (e.g., below the central section 132) and extend along a width of the harness 100. In some embodiments, the central section 132, top section 128, and bottom section 130 are a uniform construct. In some embodiments, the first side 120 includes a third visual appearance (e.g., pattern, design, color) and the second side 122 includes a fourth visual appearance that is different than the third visual appearance. In some embodiments, the third and fourth visual appearances of the first and second sides 120, 122 of the back panel 104 are different from the first and second visual appearances of the first and second sides 116, 118 of the chest panel 102.

In some embodiments, the back panel 104 includes one or more channels configured to couple the second plurality of straps 105 to the back panel 104. For example, the back panel 104 may include a first bottom section opening 113a and a second bottom section opening 113b. The first bottom section opening 113a and bottom section opening 113b may be similar to the bottom section openings 112a, 112b of the chest panel 102. For example, there may be a channel extending between the first bottom section opening 113a and the second bottom section opening 113b that the first strap 105a may pass through. The back panel 102 may include a first top section opening 115a and a second top section opening 115b. There may be a channel extending between the first top section opening 115a and second top section opening 115b that the second strap 105b may pass through. In some embodiments, the channel extending between the bottom section openings 113a and 113b and/or the channel extending between the top section openings 115a and 115b may be sandwiched between the first side 120 and second side 130 of the back panel 104. In this manner, the portions of the first strap 105a and second strap 105b that is positioned within the respective channels is not exposed at an exterior surface of the back panel 104. In some embodiments, one or more of the first strap 105a and second strap 105b may be rotated and/or moved within the corresponding channels. In some embodiments, one or more of the first strap 105a and second strap 105b may be decoupled from the corresponding channel. For example, the straps 105a and 105b may be slid into and out of the corresponding channels. In other embodiments, the straps 105a and 105b are fixedly coupled to the back panel 104.

In FIGS. 6A-6B, the second fasteners 107b coupled to the first strap 105a are the female members of a side release buckle and the second fasteners 107b coupled to the second strap 105b are male members of a side release buckle. The placement of the male and female members included in the second fasteners 107b may correspond to the placement of the male and female members included in the first fasteners 107a. For example, in FIGS. 5A-5B the first fasteners 107a coupled to the first strap 103a are illustrated as being the male members and, in FIGS. 6A-6B, the second fasteners 107b are illustrated as being the female members. The first and second fasteners 107a, 107b coupled to the second straps 103b, 105b may be generally similar in that the second strap 103b of the chest panel 102 includes one half of the type of fastener and the second strap 105b of the back panel 104 includes the remaining half of said type of fastener. In some embodiments, each of the second fasteners 107b coupled to the first strap 105a and second strap 105b may be the male or female members of a type of fastener. For example, the second fasteners 107b, coupled to the first strap 105a and second strap 105b, may be the remaining half of a type of fastener that is coupled to the straps 103a and 103b of the chest panel 102. Put another way, if the chest panel 102 includes first fastening members 107a that are each the male member of a side release buckle, the back panel 104 may include second fastening members 107b that are each the female member of a side release buckle, or vice versa.

In some embodiments, by providing first fastening members 107a coupled to each terminal end of the first plurality of straps 103 of the chest panel 102 (shown in FIGS. 5A-5B) and second fastening members 107b coupled to the second plurality of straps 105 of the back panel 104 (shown in FIGS. 6A-6B) that correspond to one another as described above, the chest panel 102 may be detachable from the back panel 104. As such, the chest panel 102 and back panel 104 may be decoupled such that one or both of the panels 102, 104 may be rotated, or reoriented, relative to and independent of one another and coupled back together. Furthermore, each side 116, 118, 120, 122 of the chest panel 102 and back panel 104 respectively may include a visual appearance that is different from each other side 116, 118, 120, 122. In this manner, the harness 100 may be configured to be in two or more configurations each having a visual appearance that is different from one another.

Referring to FIGS. 7A-7D, the harness 100 is shown in different configurations each having a visual appearance that is different from each other configuration. The “visual appearance” may refer to the appearance of the outwardly facing sides of the corresponding chest panel 102 and back panel 104. For example, the second side 118 of the chest panel 102 and first side 120 of the back panel 104 may be facing towards one another in a first configuration, thereby resulting in the first side 116 of the chest panel 102 and the second side 120 of the back panel 104 being outwardly facing (e.g., facing away from one another and away from the body of a pet wearing the harness 100).

In some embodiments, the harness 100 is configured to be in a first configuration where the first side 116 of the chest panel 102 and second side 122 of the back panel 104 are outwardly facing, as shown in FIG. 7A. The first configuration may be characterized by the second side 118 of the chest panel 102 and the first side 120 of the back panel 104 facing one another. In some embodiments, the harness 100 is configured to be in a second configuration where the first side 116 of the chest panel 102 and the first side 120 of the back panel 104 are outwardly facing, as shown in FIG. 7B. The second configuration may be characterized by the second side 118 of the chest panel 102 and the second side 122 of the back panel 104 facing one another. In some embodiments, the harness 100 may be configured to be in a third configuration where the second side 118 of the chest panel 102 and the second side 122 of the back panel 104 are outwardly facing, as shown in FIG. 7C. The third configuration may be characterized by the first side 116 of the chest panel 102 and the first side 120 of the back panel 104 facing one another. In some embodiments, the harness 100 is configured to be in a fourth configuration where the second side 118 of the chest panel 102 and first side 120 of the back panel 104 are outwardly facing, as shown in FIG. 7D. The fourth configuration may be characterized by the first side 116 of the chest panel 102 and the second side 122 of the back panel 104 facing one another.

In some embodiments, the first fastening member(s) 107a and second fastening member(s) 107b may be engaged with one another (e.g., directly coupled to one another) when the harness 100 is in any one of the configurations illustrated in FIGS. 7A-7D. In some embodiments, one or more of the straps 103a, 103b, 105a, 105b, may be rotated, moved, or reoriented relative to the corresponding chest panel 102 and back panel 104 and within the channels defined by said panels 102, 104.

Referring to FIG. 1, the harness 100 may include one or more adjustable rings configured to protrude outwardly from the chest panel 102 and/or back panel 104 when the harness 100 is in any of the configurations discussed above (e.g., first, second, third, and fourth configurations). In some embodiments, the harness 100 may include a first ring 134 coupled to the chest panel 102 and/or a second ring 136 coupled to the back panel 104. Each of the first ring 134 and second ring 136 may be configured to receive a leash or rope. In some embodiments, one or more of the first ring 134 and second ring 136 is a D-Ring (e.g., having a generally D-shape). In other embodiments, one or more of the first ring 134 and second ring 136 may be generally circular, generally rectangular, generally square, or generally triangular in shape. In some embodiments, one or more of the first ring 134 and second ring 136 includes a first portion that is generally linear and a second portion having a semi-circular shape and disposed opposite the first portion. In some embodiments, there are elongated portions on either side of the first portion that connects the first portion to the second portion. In some embodiments, the first ring 134 is a unitary construct. In some embodiments, the second ring 136 is a unitary construct.

In some embodiments, the first ring 134 and/or second ring 136 is comprised of a metal (e.g., steel, aluminum, nickel-plated steel, stainless steel, zinc die cast, brass). In other embodiments, the first chest ring 134 and/or second chest ring 136 is comprised of a plastic. In some embodiments, the first ring 134 and/or second ring 136 has any one of an outer width of about 15 mm, about 20 mm, about 25 mm, about 30 mm, and about 40 mm. In some embodiments, the first ring 134 and/or second ring 136 has an inner width of about 10 mm, about 12 mm, about 14 mm, about 16 mm, about 18 mm, about 20 mm, about 22 mm, about 24 mm, about 26 mm, about 28 mm, about 30 mm, about 32 mm, about 34 mm, and about 36 mm. In some embodiments, the first ring 134 and/or second ring 136 has any one of an outer length of about 15 mm, about 20 mm, about 25 mm, about 30 mm, and about 40 mm. In some embodiments, the first ring 134 and/or second ring 136 has an inner length of about 10 mm, about 12 mm, about 14 mm, about 16 mm, about 18 mm, about 20 mm, about 22 mm, about 24 mm, about 26 mm, about 28 mm, about 30 mm, about 32 mm, about 34 mm, and about 36 mm. In some embodiments, the first ring 134 and/or second ring 136 has a thickness of about 4.5 mm. In other embodiments, the first ring 134 and/or second ring 136 has any one of a thickness of about 2.0 mm, 2.5 mm, 3.0 mm. and 4.0 mm

In some embodiments, there may be a third ring 137 coupled to the back panel 104. In some embodiments, the third ring 137 may be generally the same as any one of the first ring 134 and second ring 136 except that the third ring 137 may be fixedly coupled to the back panel 104 along a periphery of the back panel 104. The third ring 137 may be rotatable relative to the back panel 104. In some embodiments, the third ring 137 is coupled to a bottom periphery of the back panel 104. In some embodiments, the third ring 137 is coupled to and extends outwardly from a periphery of the back panel 104.

The chest panel 102 may include an opening 138 extending from the first side 116 to the second side 118. In some embodiments, the opening 138 extends through the thickness of the chest panel 102. In some embodiments, the chest panel 102 includes a first reinforced padding 140 and a second reinforced padding 142 (shown in FIG. 5B) each including a first aperture that defines the opening 138. In some embodiments, the first reinforced padding 140 is directly coupled to the first side 116 of the chest panel 102. In some embodiments, the first reinforced padding 140 is stitched onto the first side 116 of the chest panel 102. In some embodiments, the second reinforced padding 142 is directly coupled to the second side 118 of the chest panel 102. In some embodiments, the second reinforced padding 142 is stitched onto the second side 118 of the chest panel 102.

In some embodiments, the back panel 104 includes an opening 144 that extends from the first side 120 to the second side 122 of the back panel 104. The opening 144 may be generally the same as the opening 138 of the chest panel 102. For example, the opening 144 may extend through the thickness of the back panel 104 from the first side 120 to the second side 122. In some embodiments, the back panel 104 includes a first reinforced padding 146 and a second reinforced padding 148 (shown in FIG. 6B) each including a second aperture that defines the opening 144. The first reinforced padding 146 and second reinforced padding 148 may be generally the same as the reinforced paddings 140, 142 of the chest panel 102. In some embodiments, the first reinforced padding 146 is directly coupled to the first side 120 of the back panel 104. In some embodiments, the first reinforced padding 146 is stitched onto the first side 120 of the back panel 104. Similarly, in some embodiments, the second reinforced padding 148 is directly coupled to the second side 122 of the back panel 104 and may be stitched onto the second side 122 of the back panel 104.

In some embodiments, the reinforced paddings 140, 142, 146, 148 are comprised of a material different from the material the chest panel 102 and/or back panel 104 is comprised of. In some embodiments, the reinforced paddings 140, 142, 146, 148 are comprised of leather, leatherette, faux leather, or any other textile capable of being sewn onto the chest panel 102 and/or back panel 104. In some embodiments, the reinforced paddings 140, 142, 146, 148 each have a generally pill shape (e.g., two rounded sides opposite one another and connected by generally horizontal upper and lower edges). In some embodiments, the reinforced paddings 140, 142, 146, 148 may have a generally square shape, generally rectangular shape, generally circular shape, generally ovular shape, or any other shape.

In some embodiments, the chest panel 102 may include a first central strap 150 configured to couple the first ring 134 to the chest panel 102. The back panel 104 may include a second central strap 152 configured to couple the second ring 136 to the back panel 104. The first central strap 150 may extend partially along a length of the chest panel 102. In some embodiments, the first central strap 150 is disposed between the first side 116 and the second side 118 of the chest panel 102. Similarly, the second central strap 152 may be disposed between the first side 120 and second side 122 of the back panel 104. In some embodiments, the first central strap 150 is coupled to at least one of the first side 116 and second side 118 of the chest panel 102 such that a portion of the first central strap 150 extends across opening 138. Similarly, the second central strap 152 may be coupled to at least one of the first side 120 and second side 122 of the back panel 104 such that a portion of the second central strap 152 extends across opening 144. In some embodiments, the first and second central straps 150, 152 are comprised of a generally rigid material. In other embodiments, the first and second central straps 150, 152 are comprised at least partially of an elastic material. In some embodiments, at least one of the first and second central straps 150, 152 is comprised of a nylon webbing. In some embodiments, the openings 138, 144 are between about 0.5 inches to 1.5 inches wide. In some embodiments the openings 138, 144 are between about 0.125 inches to 0.25 inches tall.

In some embodiments, a portion of the first and second central straps 150, 152 are visible through the respective openings 138, 144. In some embodiments, the first and second central straps 150, 152 are extend above and below the respective openings 138, 144. In some embodiments, at least one end of each of the first and second central straps 150, 152 that extends above or below the respective opening 138, 144 is fixedly coupled (e.g., stitched to, adhered to) to the respective chest or back panel 102, 104. In some embodiments, both ends of the first and second central straps 150, 152 that are positioned above and below the respective openings 138, 144 are fixedly coupled to the respective chest or back panel 102, 104. In some embodiments, each of the first and second central straps 150, 152 have a width that is less than the width of the corresponding opening 138, 144. In some embodiments, the first and second central straps 150, 152 are positioned within the corresponding openings 138, 144 such that opposing sections of the corresponding rings 134, 136 may pass through the corresponding openings 138, 144. In other embodiments, the central straps 150, 152 may have a width which is the same or larger than the corresponding opening 138, 144. In other embodiments, one or more of the central straps 150, 152 includes one or more apertures that the corresponding first or second chest ring 134, 136 extends through. In other embodiments, the chest panel 102 and/or back panel 104 includes one or more apertures which the corresponding first or second chest ring 134, 136 extends through and may or may not include the corresponding central strap 150, 152. In some embodiments, one or more of the first and second central strap 150, 152 is comprised of a textile such as, but not limited to: polyester, neoprene, or nylon.

In some embodiments, each of the first ring 134 and second ring 136 include a respective ring opening configured to allow the corresponding central strap 150, 152 to pass therethrough. For example, the different portions of the first ring 134 and second ring 136 (e.g., the first portion, second portion, and elongated portions discussed above) may define an opening that the ring 134, 136 extends around. The central strap 150, 152 may pass through the opening in the corresponding ring 134, 136 thereby coupling the ring 134, 136 to the corresponding chest panel 102 and back panel 104.

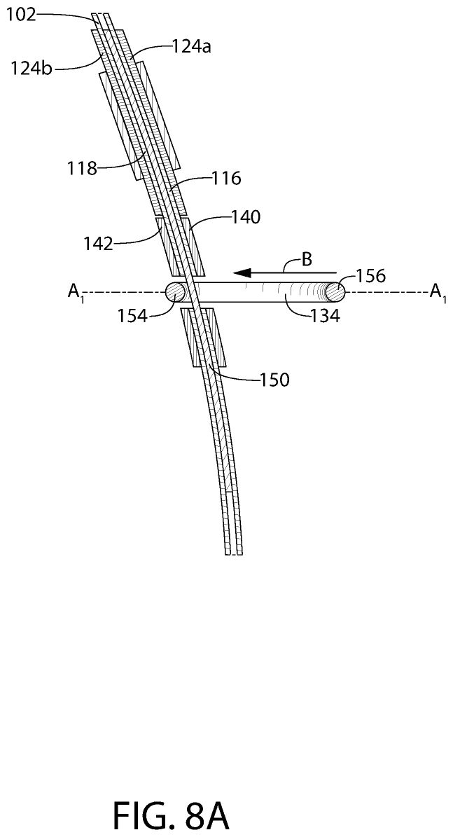

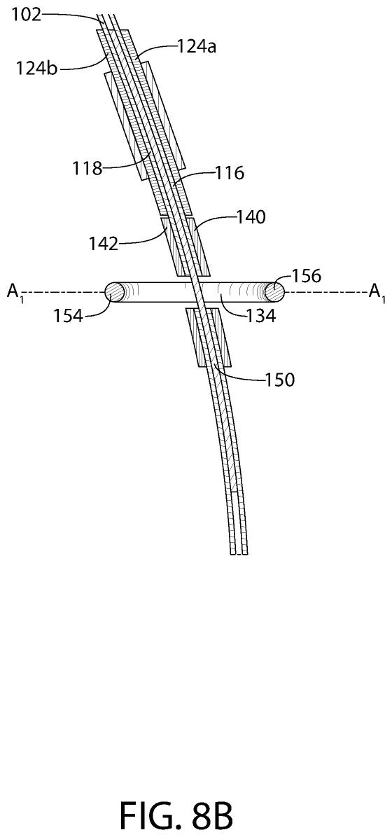

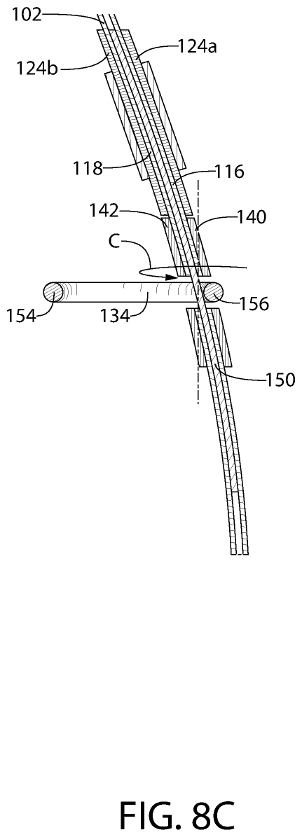

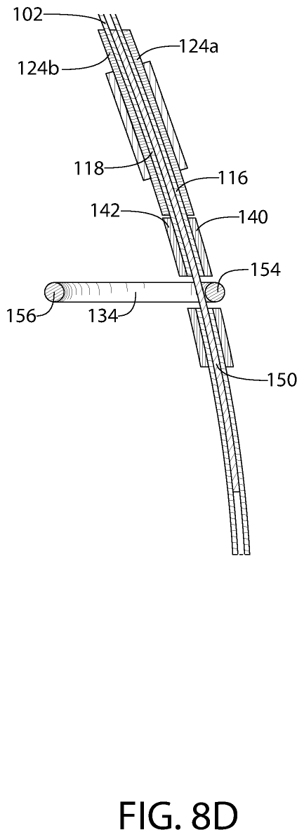

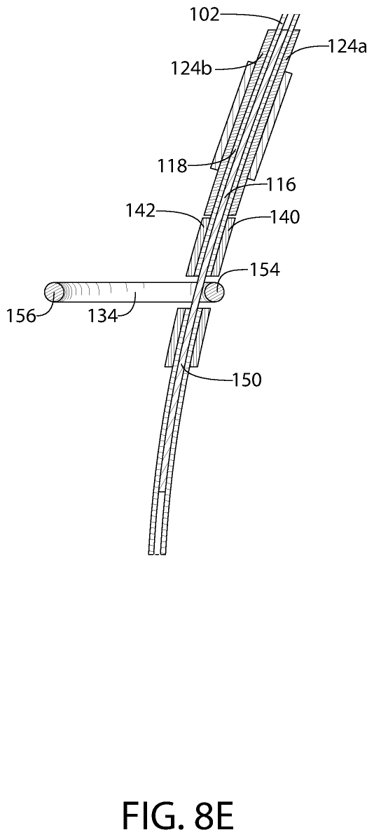

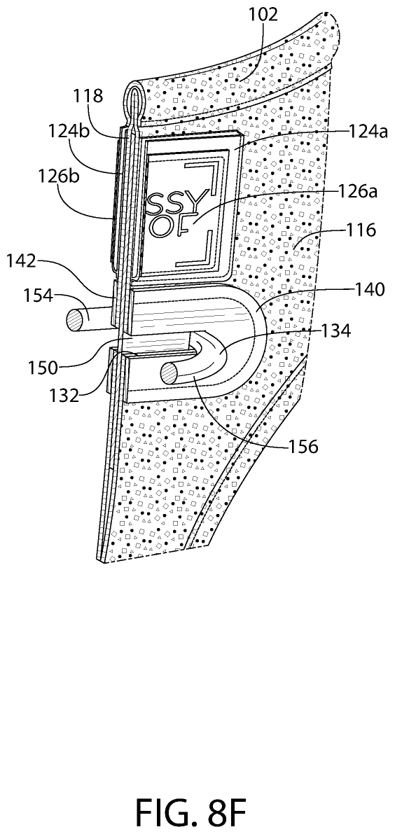

For example, and referring to FIG. 8F, the first ring 134 may include a first portion 154 and a second portion 156 opposite the first portion 154. The first portion 154 of the first ring 134 is disposed on one side of the first central strap 150 while the second portion 156 is disposed on the opposite side of the first central strap 150. Although FIG. 8F illustrates the chest panel 102 and first ring 134 coupled thereto by the first central strap 150, it will be understood that the second ring 136 may be coupled to the back panel 104 in generally the same manner as described with reference to FIG. 8F. In some embodiments, the first ring 134 may be repositionable such that the position of the first ring 134 relative to the first central strap 150 transitions from a first position to a second position. In some embodiments, the first central strap 150 passing through the opening defined by the first ring 134 allows the first ring 134 to be adjusted relative to the first central strap 150. For example, the second portion 156 of the first ring 134 may be adjusted such that the second portion 156 extends outward from the first side 116 of the chest panel 102 while the first portion 154 extends toward or outwardly from the second side 118 and vice versa. In some embodiments, the first ring 134 is not rigidly coupled to the first central strap 150. For example, the first ring 134 may define an opening located in the center of the first ring 134. The first central strap 150 may pass through the opening located in the center of the first ring 134, such that the first ring 134 is coupled to the first central strap 150 without any one location along the first ring being fixed relative to the first central strap 150.

As mentioned above, it will be understood that the foregoing description of the first ring 134 coupled to the chest panel 102 via the first central strap 150 may be applied to the coupling of the second ring 136 to the back panel 104 via the second central strap 152. As such, the coupling of the second ring 136 to the back panel 104 via the second central strap 152 will not be discussed for sake of brevity.

In some embodiments, the first ring 134 and second ring 136 are each repositionable between a first position and second position such that a leash or lead may be attached to the harness 100 when the harness 100 is any one of the above four configurations as discussed with reference to

FIGS. 7A-7D. In some embodiments, each of the first ring 134 and second ring 136 are configured to attach a leash and/or lead to the harness 100 without causing the respective ring 134, 136 to be pressed into a pet's skin and/or fur during use such that the rings 134, 136 cause discomfort to the pet. In some embodiments, a portion (e.g., first portion 154) may partially abut a pet's fur or skin when the harness 100 is worn by the pet in any of the four configurations discussed above.

Referring to FIGS. 8A-8E, there is shown a magnified cross-sectional view of harness 100 depicting an example of the first ring 134 adjusted between a first position and a second position. It will be understood that the following examples and description of the first ring 134 being adjusted between the first position and second position may apply to a similar adjustment of the second ring 136 being adjusted between a first position and second position, and as such, adjustment of the second ring 136 between said positions will not be discussed for sake of brevity.

As shown in FIG. 8A, the first ring 134 is in a first position, wherein the second portion 156 of the first ring 134 extends outwardly from the first side 116 of chest panel 102. As indicated by arrow B, the second portion 156 of the first ring 134 may be moved towards the first central strap 150, along axis A1, such that the second portion 156 is closer to the first central strap 150 than the first portion 154. In some embodiments, a user manually moves the first ring 134 along axis A1. In other embodiments, the first ring 134 may be partially moved along Axis A1 and a leash may be attached to the first ring 134 to pull the first ring 134 along Axis A1 such that the first ring 134 extends from an exterior surface of the chest panel 102 (as shown in FIG. 8C). In other embodiments, the first ring 134 may be partially moved along Axis A1 and the pet harness 100 may be coupled to a pet causing the chest of the pet to push the first ring 134 to extend from an exterior surface of the chest panel 102 (as shown in FIG. 8C). As shown in FIG. 8B, the first ring 134 has been moved a first distance along axis A1 in the direction indicated by arrow B such that the first portion 154 has been moved away from second side 118 and the second portion 142 has been moved towards the second side 118. As indicated by arrow B, the second portion 156 of the first ring 134 may be moved further towards the first central strap 150, along axis A1, such that the second portion 156 is moved towards the first central strap 150. Referring to FIG. 8G, a perspective view of the position of the first ring 134 in the position shown in FIG. 8B is depicted. As can be seen in the figure, the first portion 154 of the first ring 134 extends outwardly from the second side 118 while the second portion 156 extends outwardly from the first side 116.

As shown in FIG. 8C, the first ring 134 has been moved such that the second portion 156 is closer to the first central strap 150 than the first portion 154. As indicated by arrow C, the first ring 134 is rotated relative to the first central strap 150 such that the first portion 154 of the first ring 134 faces the first side 116 of the chest panel 102 (as shown in FIG. 8D). In some embodiments, the first ring 134 is rotated by about 180° by a user. As shown in FIG. 8D, the first ring 134 is in the second position, following the movement towards and rotation about the first central strap 150. It will be understood that the first ring 134 may alternatively be rotated relative to the first central strap 150 and then moved relative the first central strap 150 such as to cause the first ring 134 to transition from the first position to the second position. In some embodiments, the repositioning of the first ring 134, as shown in FIGS. 8A-8D, may take place prior to, during, or after the harness 100 is transitioned between any of the configurations, as shown in FIGS. 7A-7D. In the example shown in FIGS. 8A-8D, the harness 100 is shown in either the first configuration (FIG. 7A) or second configuration (FIG. 7B) (e.g., first side 116 outwardly facing) throughout, however the harness 100 may be reversed to another configuration at any point before, during, or after the repositioning of the first ring 134. For example, the harness 100 is transitioned from one of the first configuration or second configuration (FIGS. 7A-7B) to one of the third or fourth configurations (FIGS. 7C-7D, where the second side 118 is outwardly facing as shown in FIG. 8E.

In some embodiments, the first ring 134 may require one or more of the translations and/or rotations illustrated in FIGS. 8A-8D for the first ring 134 to be repositioned between the first and second positions, depending on the geometry of the first ring 134. In some embodiments, the first ring 134 may be a generally circular shaped ring, such as an O-shape ring, which may be repositioned from a first position to a second position in a similar manner as shown in FIGS. 8A-8B. For example, a first ring 134 having a generally circular shape may be repositioned between a first position and a second position by translating the first ring 134 along axis A1 without requiring that the first ring 134 be rotated about axis A2 as shown in FIG. 8C. Similarly, a first ring 134 having a generally square or rectangular shape may be transitioned between a first position and a second position without requiring rotation about axis A2.

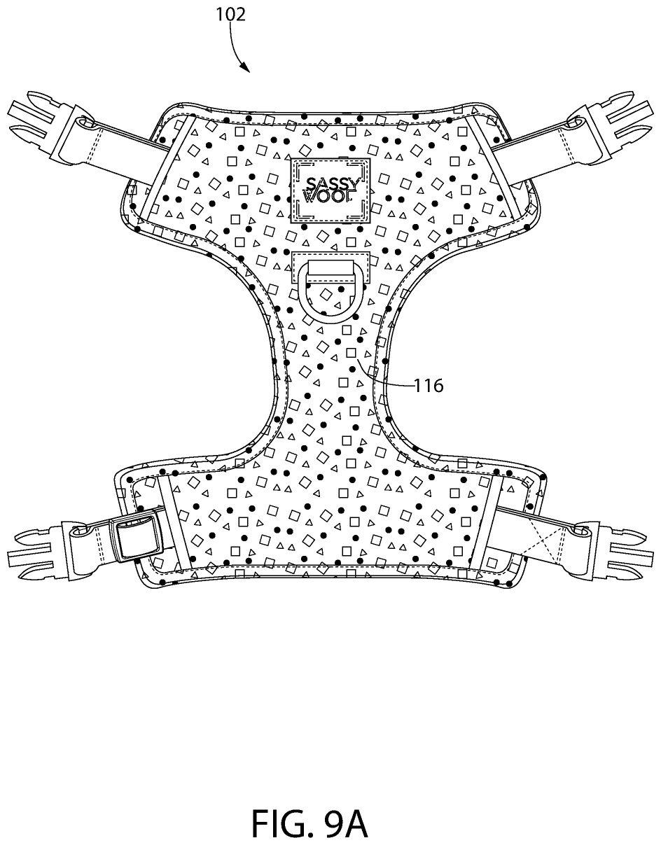

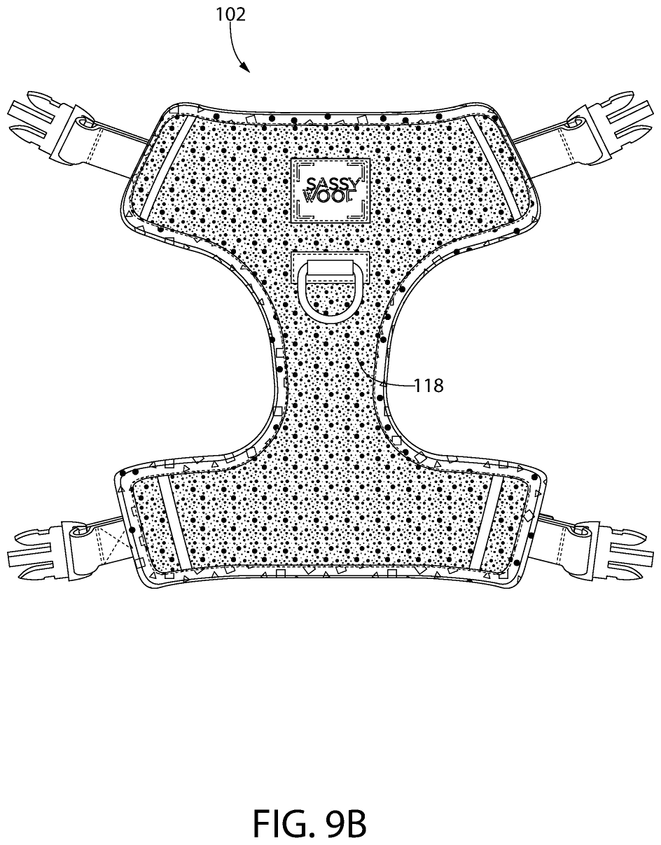

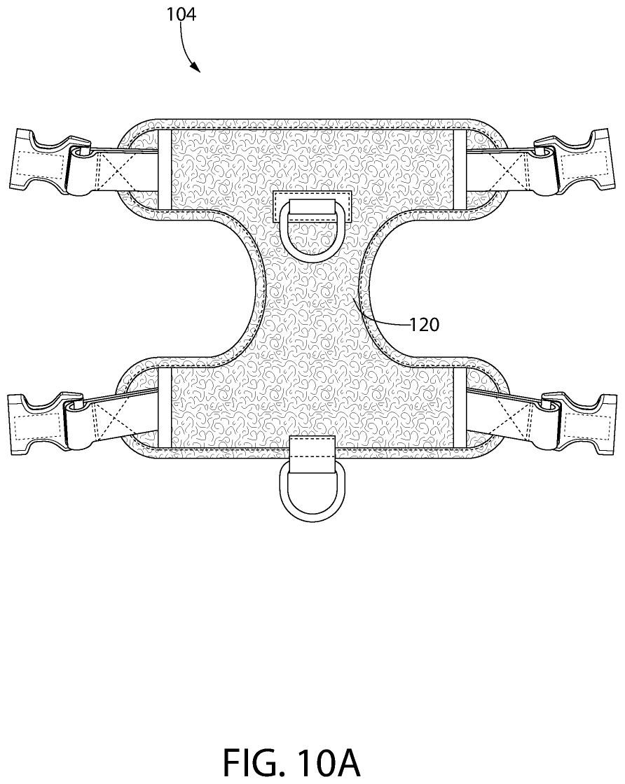

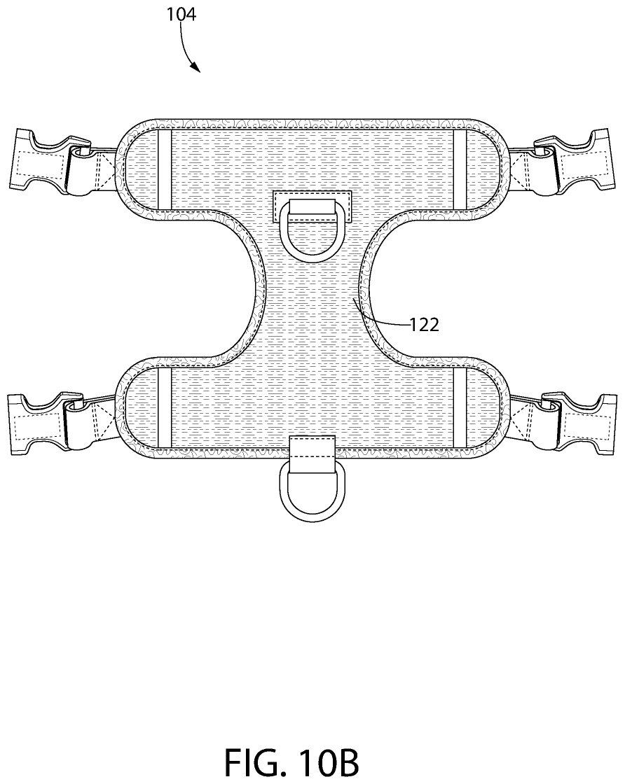

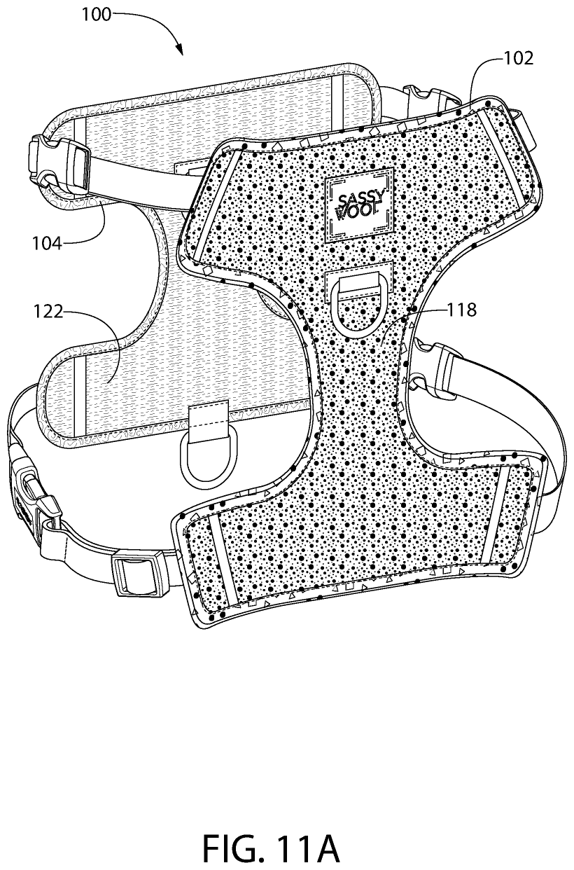

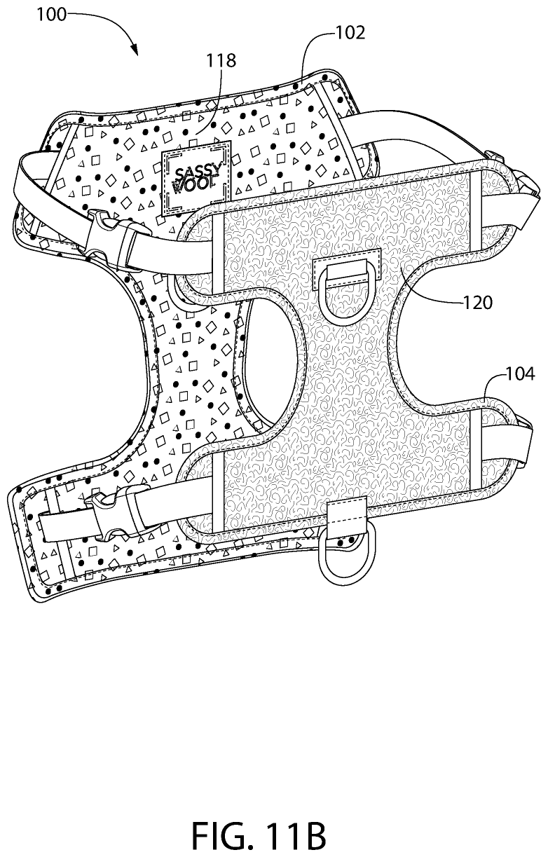

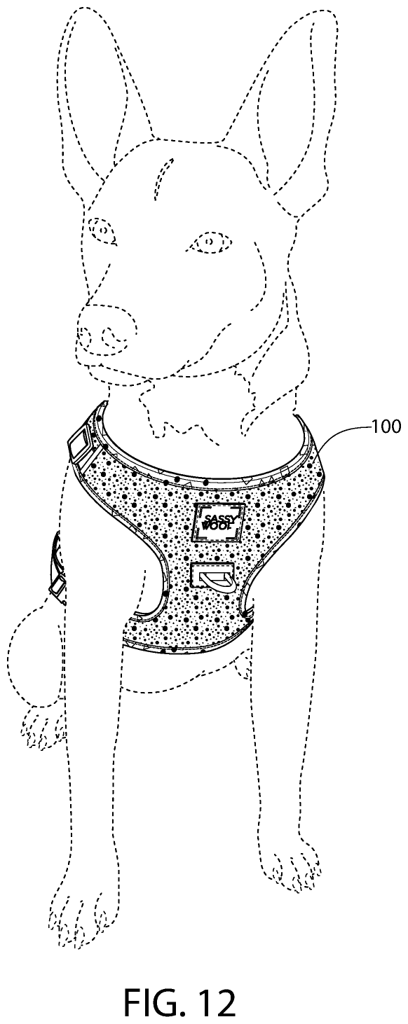

Referring to FIG. 9A, there is shown a front elevational view of the chest panel 102 having a first side 116 with a first visual appearance. Referring to FIG. 9B, there is shown a rear elevational view of the chest panel 102 having a second side 118 with a second visual appearance that is different from the first visual appearance. Referring to FIG. 10A, there is shown a front elevational view of the back panel 104 having a first side 120 with a third visual appearance that is different from the first and second visual appearances of the chest panel 102 shown in FIGS. 9A-9B. Referring to FIG. 10B there is shown a rear elevational view of the back panel 104 having a second side 122 with a fourth visual appearance that is different from the first and second visual appearances of the chest panel 102 shown in FIGS. 9A-9B and the third visual appearance of the first side 120 of the back panel 104. Referring to FIGS. 11A-11B, there is shown the harness 100 including the chest panel 102 shown in FIGS. 9A-9B and back panel 104 shown in FIGS. 10A-10B coupled together in the fourth configuration (FIG. 7D) in which the second side 116 of the chest panel 102 and the first side 120 of the back panel 104 are outwardly facing. Referring to FIG. 12, the harness 100 is shown coupled to a dog in the fourth configuration.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. The words “inwardly” and “outwardly” refer to directions toward and away from, respectively, the geometric center of the reversible pet harness. Unless specifically set forth herein, the terms “a”, “an” and “the” are not limited to one element but instead should be read as meaning “at least one”.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A reversible harness for a pet comprising:
a chest panel having a first side and a second side opposite the first side;
a first plurality of straps coupled to the chest panel and configured to secure the chest panel to a chest of the pet, the first plurality of straps including at least one first fastening member coupled to at least one strap of the first plurality of straps;
a back panel having a first side and a second side opposite the first side; and
a second plurality of straps coupled to the back panel and configured to secure the back panel to a back of the pet, the second plurality of straps including at least one second fastening member coupled to at least one strap of the second plurality of straps and configured to detachably couple to the at least one first fastening member,
wherein the reversible harness is adjustable between a first configuration in which the second side of the chest panel faces the first side of the back panel and a second configuration in which the first side of the chest panel faces the second side of the back panel.

2. The reversible harness of claim 1 further comprising:
a first aperture defining an opening extending through the chest panel from the first side to the second side of the chest panel;
a first ring positioned in the opening and defining a first ring opening; and
a first central strap extending across the opening of the first aperture and through the first ring opening of the first ring to moveably couple the first ring relative to the chest panel, the opening of the first aperture and first central strap configured to allow the first ring to extend outwardly at least primarily from the first side of the chest panel in a first position and outwardly at least primarily from the second side of the chest panel in a second position.

3. The reversible harness of claim 2, wherein the first central strap is sandwiched between the first side and the second side of the chest panel and extends above and below the first aperture.

4. The reversible harness of claim 2, wherein the first central strap is fixedly coupled to the chest panel.

5. The reversible harness of claim 2 further comprising:
a second aperture defining an opening extending through the back panel from the first side to the second side of the back panel;
a second ring positioned in the opening of the second aperture and defining a second ring opening; and
a second central strap extending across the opening of the second aperture and through the second ring opening of the second ring to moveably couple the second ring relative to the back panel, the opening of the second aperture and second central strap configured to allow the second ring to extend outwardly at least primarily from the first side of the back panel in a first position and outwardly at least primarily from the second side of the back panel in a second position.

6. The reversible harness of claim 5, wherein the second central strap is sandwiched between the first side and the second side of the back panel and extends above and below the second aperture.

7. The reversible harness of claim 5, wherein the second central strap is fixedly coupled to the back panel.

8. The reversible harness of claim 5, wherein the first ring and second ring are each D-shaped rings.

9. The reversible harness of claim 1, wherein the reversible harness is adjustable between the first configuration, the second configuration, a third configuration in which the second side of the chest panel faces the second side of the back panel, and a fourth configuration in which the first side of the chest panel faces the first side of the back panel.

10. The reversible harness of claim 9, wherein the at least one second fastening member engages the at least one first fastening member when the reversible harness is in the third configuration and the fourth configuration.

11. The reversible harness of claim 9, wherein the first plurality of straps includes four first fastening members and the second plurality of straps includes four second fastening members, each of the four first fastening members configured to detachably couple to any one of the four second fastening members.

12. The reversible harness of claim 1, wherein the back panel is detachable from the chest panel.

13. The reversible harness of claim 1, wherein the chest panel defines one or more channels extending at least partially between the first side and second side of the chest panel and configured to adjustably couple the first plurality of straps to the chest panel.

14. The reversible harness of claim 1, wherein the back panel defines one or more channels extending at least partially between the first side and second side of the back panel and configured to adjustably couple the second plurality of straps to the back panel.

15. The reversible harness of claim 1, wherein the first side of the chest panel includes a first pocket fixedly coupled to the first side of the chest panel, and
wherein the second side of the chest panel includes a second pocket fixedly coupled to the second side of the chest panel.

16. The reversible harness of claim 1, wherein the back panel includes a ring coupled to and extending outwardly from a periphery of the back panel.

17. The reversible harness of claim 1, wherein the chest panel and back panel are each comprised of a fabric material.

18. The reversible harness of claim 1, wherein the first side and second side of each of the chest panel and back panel include a color or pattern than that is different than each other first side and second side of each of the chest panel and back panel.

19. A reversible pet harness comprising:
a chest panel including a first side and a second side;
a back panel including a first side and a second side, the back panel and chest panel oriented relative to one another such that the first side of the back panel faces the second side of the chest panel; and
a plurality of straps detachably coupling the chest panel to the back panel,
wherein the orientation of each of the chest panel and back panel are reversible relative to and independent of the other.

20. A reversible pet harness comprising:
a chest panel having a first side and a second side opposite the first side;
a first plurality of straps coupled to the chest panel and configured to secure the chest panel to a chest of a pet, the first plurality of straps including at least one first fastening member coupled to at least one strap of the first plurality of straps;
a first aperture defining an opening extending through the chest panel from the first side to the second side of the chest panel;
a first ring positioned in the opening and defining a first ring opening; and
a first central strap extending across the opening of the first aperture and through the first ring opening of the first ring to moveably couple the first ring relative to the chest panel, the opening of the first aperture and first central strap configured to allow the first ring to extend outwardly at least primarily from the first side of the chest panel in a first position and outwardly at least primarily from the second side of the chest panel in a second position;
a back panel having a first side and a second side opposite the first side;
a second plurality of straps coupled to the back panel and configured to secure the back panel to a back of the pet, the second plurality of straps including at least one second fastening member coupled to at least one strap of the second plurality of straps;
a second aperture defining an opening extending through the back panel from the first side to the second side of the back panel;
a second ring positioned in the opening of the second aperture and defining a second ring opening; and
a second central strap extending across the opening of the second aperture and through the second ring opening of the second ring to moveably couple the second ring relative to the back panel, the opening of the second aperture and second central strap configured to allow the second ring to extend outwardly at least primarily from the first side of the back panel in a first position and outwardly at least primarily from the second side of the back panel in a second position,
wherein the reversible harness is adjustable between a first configuration in which the second side of the chest panel faces the first side of the back panel and a second configuration in which the first side of the chest panel faces the second side of the back panel, and
wherein the at least one second fastening member engages the at least one first fastening member when the reversible harness is in the first configuration and the second configuration.
